(19) United States
(12) Patent Application Publication
(10) Pub. No.: US 2011/0010933 A1
(43) Pub. Date: Jan. 20, 2011

(54) Multi-functional tool and method of using same

(76) Inventor: Sam Van Duyne, Wilmington, IL (US)

Correspondence Address: MCCRACKEN & FRANK LLP, 311 S. WACKER DRIVE, SUITE 2500, CHICAGO, IL, 60606, US

(21) Appl. No.: 12/460,491

(22) Filed: Jul. 20, 2009

(51) Int. Cl. H01R 43/20; B23P 19/00

(52) U.S. Cl. 29/876; 29/745

(57) ABSTRACT

A multi-functional tool includes a shaft having first and second ends and a first, implement extending from the first end. The tool further includes a second implement extending from the second end and including a base and first and second posts extending from the base. A gap is disposed between the first and second posts and adapted to receive a connector therebetween during locking of the connector to an electrical box.

### CROSS REFERENCE TO RELATED APPLICATIONS

Not applicable

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present invention relates generally to multi-functional tools, and more particularly to multi-functional tools for securing sections of wire casing to a conventional electrical box.

2. Description of the Background of the Invention

In order to run wiring for residential and commercial use for outlets, switches, fans, lamps, built-in electrical appliances, and the like, it is necessary for electricians to connect wire casing, such as for example, conduit, armored cable, armored sheath, plastic-sheathed tubing, and the like, to conventional electrical boxes. In doing so, an electrician must use tools to remove one or more knockouts from the electrical box, for example, a single box, a duplex box, ganged electrical box sections, and/or any other form of electrical enclosure. Specifically, tools such as a hammer and screw driver, or any other suitable available tool(s) is used to apply pressure to the knockouts to deform and break a metal connecting portion that connects each knockout to a remainder of the electrical box. Once a knockout has been removed, it is necessary to fasten a section of wire casing to the electrical box. The section of wire casing is fastened to the electrical box by inserting a threaded end of a connector through a hole in the electrical box formed where the knockout was removed so that the threaded end is disposed within an interior of the electrical box. A locking ring is thereafter threaded onto the threaded end of the connector until a wall of the electrical box is held tightly between the connector member and the threaded ring, for example, a lock ring. A pair of pliers, for example, Channellock® brand pliers, or a wrench is typically used to tighten the threaded ring against the inside wall of the electrical box.

Before connection to the electrical box, wire casing is generally cut to a desired length, potentially leaving residual shavings and jagged edges where the section of wire casing was cut. A reamer or deburring instrument is oftentimes used to deburr the section of wire casing. The section of wire casing is then inserted into a non-threaded end of the connector opposite the threaded end and a screw extending through the connector is tightened such that an end of the screw is driven into the section of wire casing to retain same within the connector. The screw may be tightened using a conventional screw driver, pliers, or a wrench.

As can be seen from the foregoing, up until now, attachment of wire casing to an electrical box has been executed utilizing multiple tools, some of which are not even intended for the purposes for which they are being utilized. It has therefore been necessary for an electrician to carry and use various tools, which is awkward, inconvenient, and complicated.

### SUMMARY OF THE INVENTION

According to one aspect of the present invention, a multi-functional tool includes a shaft having first and second ends and a first implement extending from the first end. The tool further includes a second implement extending from the second end and including a base and first and second posts extending from the base. A gap is disposed between the first and second posts and adapted to receive a connector therebetween during locking of the connector to an electrical box.

According to a further aspect of the present invention, a multi-functional tool includes a shaft having first and second ends and a first implement extending from the first end, wherein the first implement includes a knockout hammer. The tool further includes a second implement extending from the second end, wherein the second implement includes a base, first and second posts extending from the base, and a locking member extending at an angle of about ninety degrees from the second post.

In yet another aspect of the present invention, a method of using a multi-functional tool comprises the steps of knocking out a portion of a knockout in an electrical box utilizing a knockout hammer of the tool and inserting an edge of the knockout into a slot disposed in a cylindrical member extending from an end of the tool. The method further includes the steps of twisting the tool to remove the knockout from the electrical box and inserting a threaded end of a connector into a hole formed in the electrical box by removal of the knockout. Still further, the method includes the steps of attaching and rotating a threaded ring along the threaded end of the connector and inserting an end of the tool into a hollow portion of the connector, wherein a cylindrical wall of the connector is located between first and second spaced posts. The method still further includes the steps of turning the tool in a clockwise manner until the electrical box is held tightly between the connector and the threaded ring, inserting a section of wire casing into the connector, and securing the section of wire casing to the connector by rotating a connector screw in the connector into engagement with the section of wire casing to retain the section of wire casing within the connector.

### BRIEF DESCRIPTION OF THE DRAWINGS

FIG. 1 is an isometric view depicting a first end of a multi-functional tool;

FIG. 2 is an isometric view showing a second end of the multi-functional tool of FIG. 1;

FIG. 3 is an elevational view of a first side of the multi-functional tool of FIG. 1;

FIG. 4 is an elevational view of a second side of the multi-functional tool of FIG. 1;

FIG. 5 is an elevational view of a third side of the multi-functional tool of FIG. 1;

FIG. 6 is an elevational view of a fourth side of the multi-functional tool of FIG. 1;

FIG. 7 is an elevational view of the second end of the multi-functional tool of FIG. 1;

FIG. 8 is an elevational view of the first end of the multi-functional tool of FIG. 1;

FIGS. 9 and 10 are side elevational views of further multi-functional tools;

FIGS. 11A-11C are side elevational views of the multi-functional tool of FIG. 1 depicting exemplary dimensions thereof;

FIG. 12 is an elevational view of the first side of the multi-functional tool of FIG. 1 depicting the insertion of the tool within a connector of an electrical box; and

FIG. 13 is an elevational view similar to that of FIG. 9 and depicting rotation of the multi-functional tool in a clockwise manner to lock the connector to the electrical box.

Other aspects and advantages of the present invention will become apparent upon consideration of the following detailed description, wherein similar structures have similar reference numerals.

### DETAILED DESCRIPTION

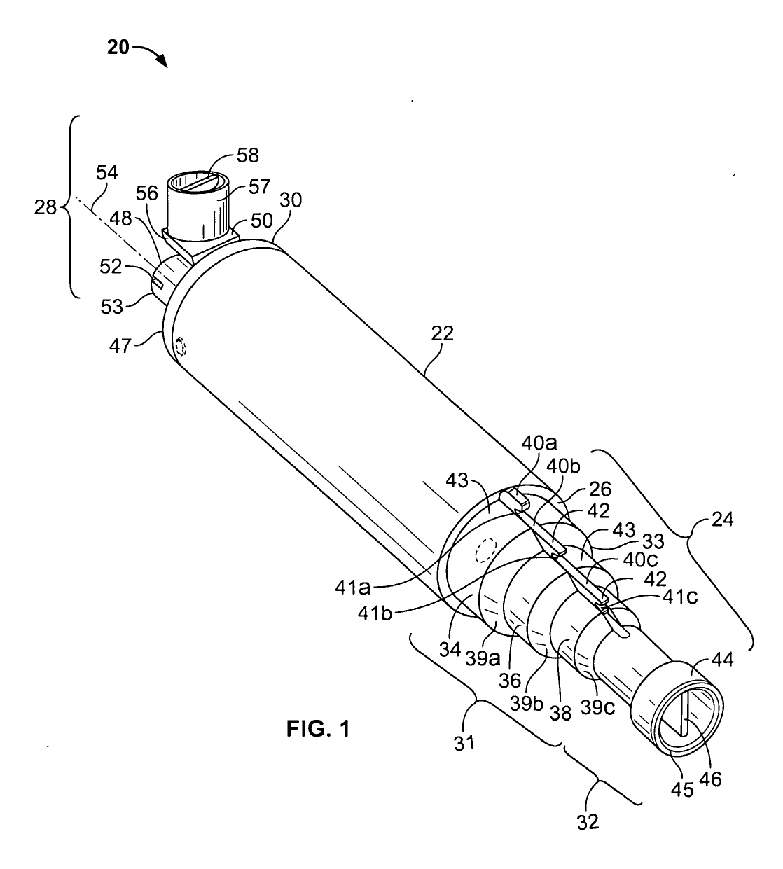

A multi-functional tool 20 for use in securing sections of wire casing to an electrical box is shown in FIGS. 1-8. Referring to FIGS. 1-6, the multi-functional tool 20 includes a shaft 22, a first implement 24 extending from a first end 26 of the shaft 22, and a second implement 28 extending from the second end 30 of the shaft 22.

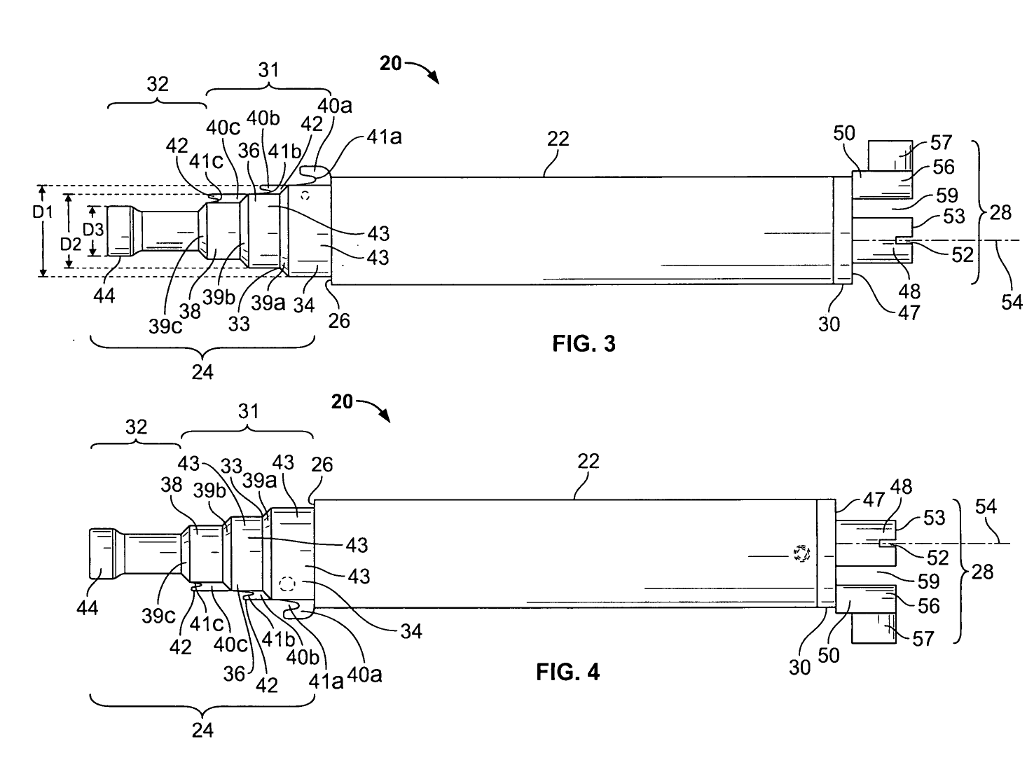

As best seen in FIGS. 1 and 3-6, the first implement 24 includes a deburring section 31 and a knockout section 32 extending outwardly from the deburring section 31. The deburring section 31 includes a body 33 formed of a first cylindrical portion 34, a second cylindrical portion 36, and a third cylindrical portion 38 connected by first and second frustro-conical portions 39a and 39b. The deburring section 31 further includes a third frusto-conical portion 39c connecting the third cylindrical portion 38 to the knockout section 32. As seen in FIG. 3, the first, second, and third cylindrical portions 34, 36, 38 have diameters D1-D3, respectively, that are different and, preferably, the diameter D1 of the first cylindrical portion 34 is greater than the diameters D2 and D3 of the second and third cylindrical portions 36, 38, respectively, and the diameter D2 of the second cylindrical portion 36 is greater than the diameter D3 of the third cylindrical portion 38. Hook-shaped members 40a-40c are integrally formed with or otherwise coupled to the deburring section 31 for deburring different sized sections of wire casing. In particular, a first hook-shaped member 40a extends outwardly past a radial extent of the first cylindrical portion 34 to form a groove 41a adjacent the first cylindrical portion 34. Second and third hook-shaped members 40b, 40c have outer surfaces 42 aligned with outer cylindrical surfaces 43 of the first and second cylindrical portions 34, 36, wherein the second and third hook-shaped members 40b, 40c form grooves 41b, 41c adjacent the second and third cylindrical portions 36, 38. The knockout section 32 includes a knockout hammer 44 extending from the deburring section 31 for use in dislodging a portion of a knockout from an electrical box, as discussed in greater detail hereinbelow. As best seen in FIGS. 1 and 8, the knockout hammer 44 includes a hollow cylindrical portion 45 at an end thereof that includes a divider 46 generally bisecting the cylindrical portion 45. The divider 46 may be used to tighten a connector screw, for example, a set screw, on a connector, as also discussed in more detail hereinafter.

Although the embodiments of multi-functional tools as depicted herein include a first implement 24 having a deburring section 31 and a knockout section 32, the deburring section 31 and/or the knockout section 32 may be replaced by another tool useful in the trade.

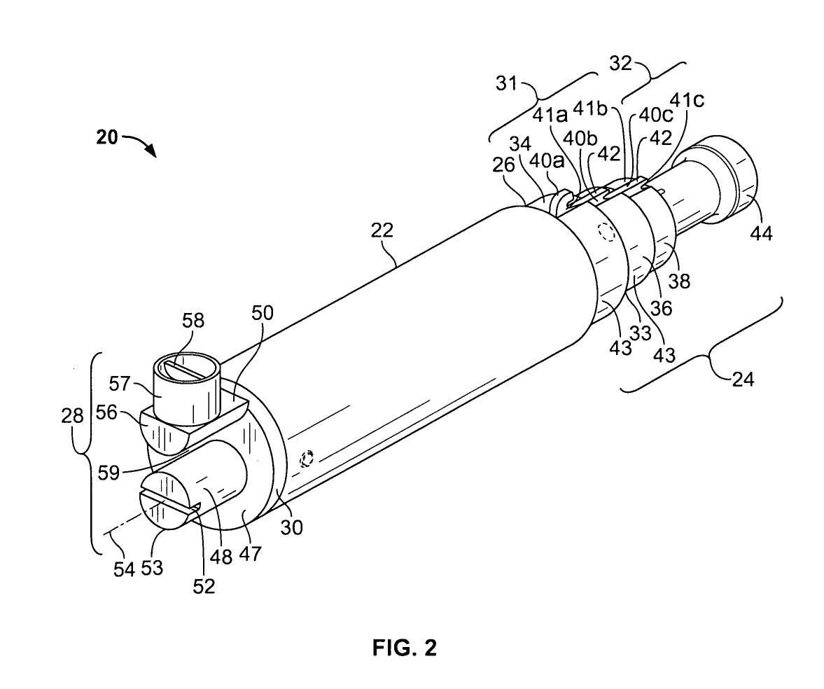

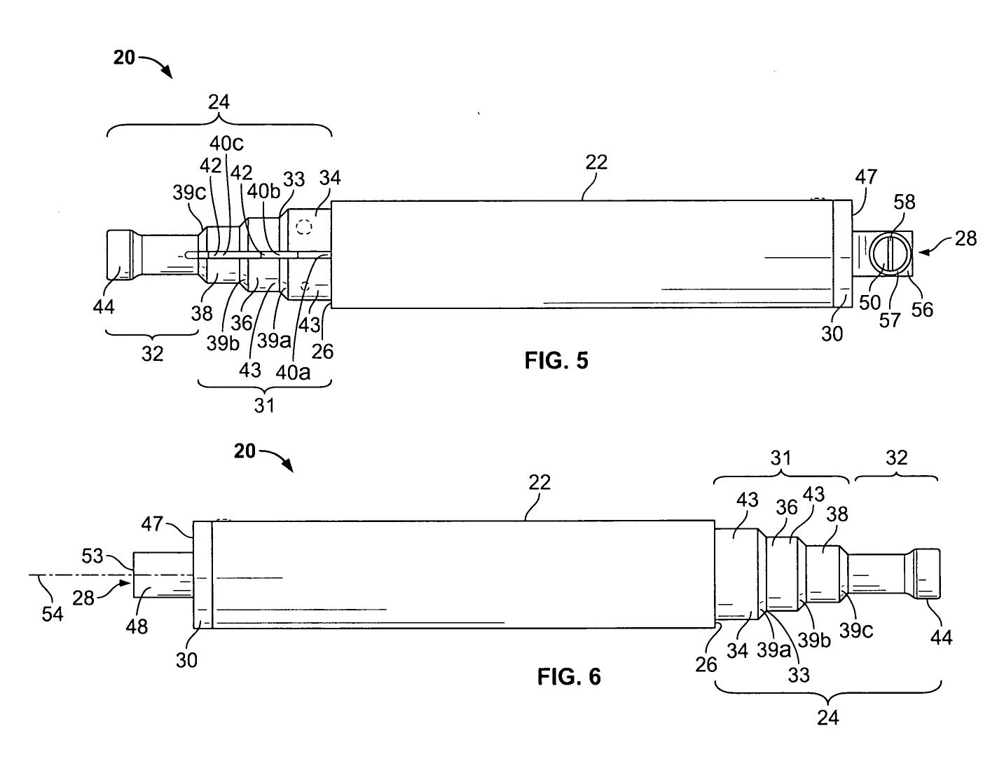

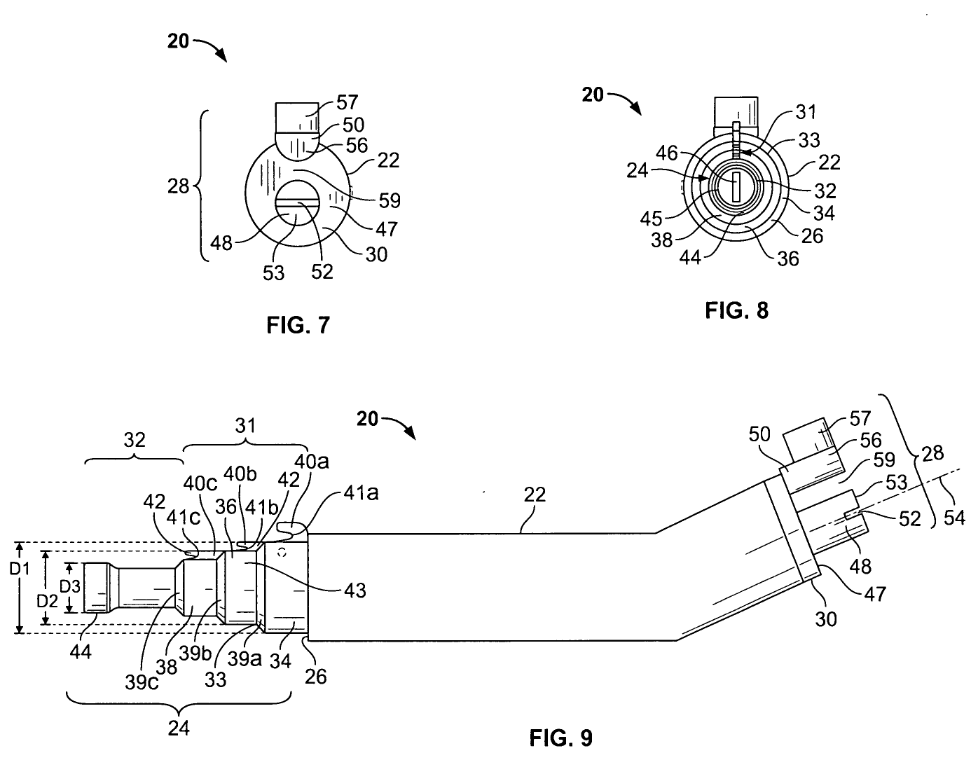

With reference to FIGS. 2-6, the second implement 28 at the second end 30 of the multi-functional tool 20 includes a base 47 and first and second posts 48, 50 extending outwardly from the base 47. Preferably, the first and second posts 48, 50 are perpendicular to the base 47. Optionally, one or both of the posts 48, 50 may be disposed at an angle with respect to the base 47. As best seen in FIGS. 2 and 7, the first post 48 is cylindrical and includes a slot 52 disposed in an end 53 thereof opposite the base 47. The slot 52 is preferably disposed along an entire cross-sectional diameter of the post 48. Optionally, the slot 52 may be disposed along only a portion of the cross-sectional diameter of the post 48 and/or the slot 52 may be offset from the diameter of the post 48, as long as the slot 52 provides a lever to remove a knockout from an electrical box, as discussed in detail below. Still further, although the slot 52 is shown as being parallel to a longitudinal extent 54 of the post 48 and having a depth that is above one-third a height of the post 48, the slot 52 may be disposed at an angle with respect to the longitudinal extent 54 of the post 48 and/or may have a greater or lesser depth, as long as the slot 52 provides a lever to remove a knockout from an electrical box. The second post 50, as best seen in FIGS. 2 and 5, includes a semi-cylindrical member 56 extending perpendicular from the base 47 and a locking member 57 coupled to and extending outwardly at about a ninety degree angle from the semi-cylindrical member 56.

Still referring to FIGS. 2 and 7, the locking member 57 is hollow and cylindrical in shape and includes a divider 58 through a central section thereof for tightening connector screws, as described hereinbelow. Although the first implement 24 includes a hollow cylindrical portion 45 and a divider 46 for tightening connector screws, the location of such elements prevents or diminishes the ability to tighten connector screws that may be located in an area that is difficult to reach, such as a screw that may be facing a wall that has little spacing between the wall and the screw. The shape, size, and orientation of the semi-cylindrical member 56 and the locking member 57 allow for easier accessibility to screws and thus, enable a user to tighten screws that may be difficult to reach and/or have little space between the screws and adjacent structures.

A gap 59 is disposed between the first and second posts 48, 50, wherein the gap 59 is great enough to accommodate a wall of a connector, as described in greater detail hereinafter. Although the posts 48, 50 are shown as being cylindrical and semi-cylindrical, respectively, in shape, such posts 48, 50 may have any shape that allows movement of a connector between the posts 48, 50, as described in detail below.

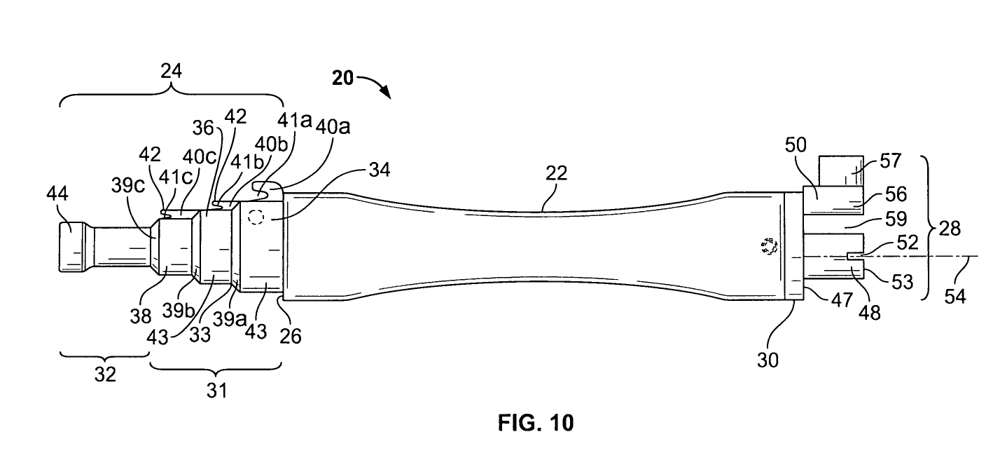

Modifications to the multi-functional tool 20 of FIGS. 1-8 may be made without departing from the scope of the present invention. For example, as seen in FIG. 9, any portion of the shaft 22 may be angled. The shaft 22 may also include a hinge, as described in greater detail hereinafter. Further, the shaft 22 may be shaped for ease in handling, as seen in FIG. 10. The shaft 22 in FIG. 10 is shown as having an hour-glass shape, but the shaft 22 may alternatively or in addition, have finger grips, indentations, and/or any other shape that facilitates ease in use.

The shaft 22 may be made of any rigid material, including plastics and metals. In addition, the deburring section 31 and the knockout section 32 of the first implement 24 and the second implement 28 are preferably made of a solid metal material, including but not limited to steel, aluminum, or any other composite material.

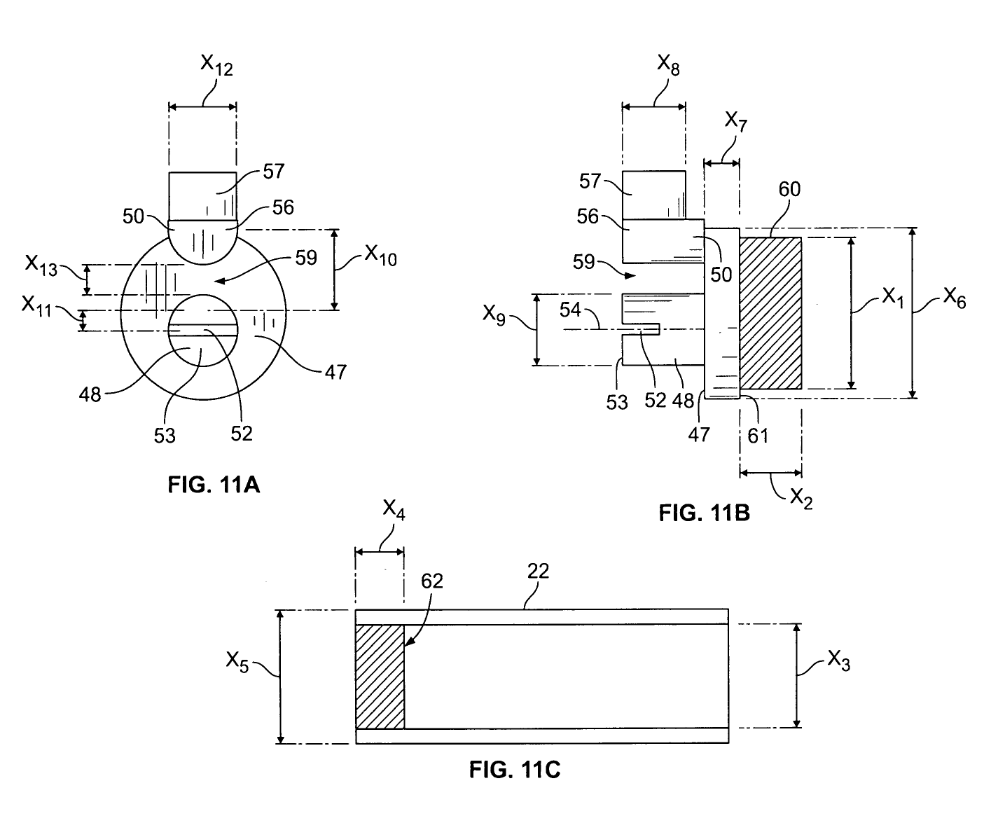

FIGS. 11A-11C depict exemplary dimensions of the shaft 22 and second implement 28 of the multi-functional tool 20. The second implement 28 is held within the shaft 22 by inserting a foot 60 that extends from a bottom surface 61 of the base 47 and has a diameter X₁ of about 1.00 inches and depth X₂ of about 0.45 inches into a hollow center 62 of the shaft 22. The foot 60 may be made of any material that may be subjected to compression, such as plastics, rubber, softer metals, and the like. The hollow center 62 of the shaft 22 has a diameter X₃ of about 0.95 inches and a depth X₄ of at least 0.50 inches to accommodate the foot 60. The foot 60 is inserted by pressure into the hollow center 62 of the shaft 22 and retained by a snug fit due to the foot 60 having a larger diameter than the hollow center 62. Screws, welding, adhesive, or any other known method of securing components may additionally be utilized to retain the second implement 28 within the shaft 22. The shaft 22 has a diameter X₅ of about 1.20 inches. The base 47 has a diameter X₆ of about 1.20 inches and a height X₇ of about 0.25 inches. Referring to FIGS. 11A and 11B, the first and second posts 48, 50 both have a height X₈ of about 0.60 inches and the first post 48 has a diameter X₉ of about 0.50 inches Since the base 47 has a radius X₁₀ of about 0.60 inches, a center of the first post 48 is a distance X₁₁ of about 0.125 inches from a center of the base 47. The second post 50 has a width X₁₂ of about inches and is spaced a distance X₁₃ from the first post 48, although the dimension X₁₃ may be any size that can accommodate a connector therebetween, as described in detail below.

Although FIGS. 11A-11C depict the shaft 22 and the second implement 28 as separate pieces, any or all of the pieces utilized to form the multi-functional tool 20 herein may be stamped, milled, molded, or otherwise formed as a single, integral unit. Optionally, any number of components may be utilized and attached to one another to form the multi-functional tool 20. Still further, a plastic or rubber portion may be molded to or with any portion of the multi-functional tool 20 to create a handle therefore.

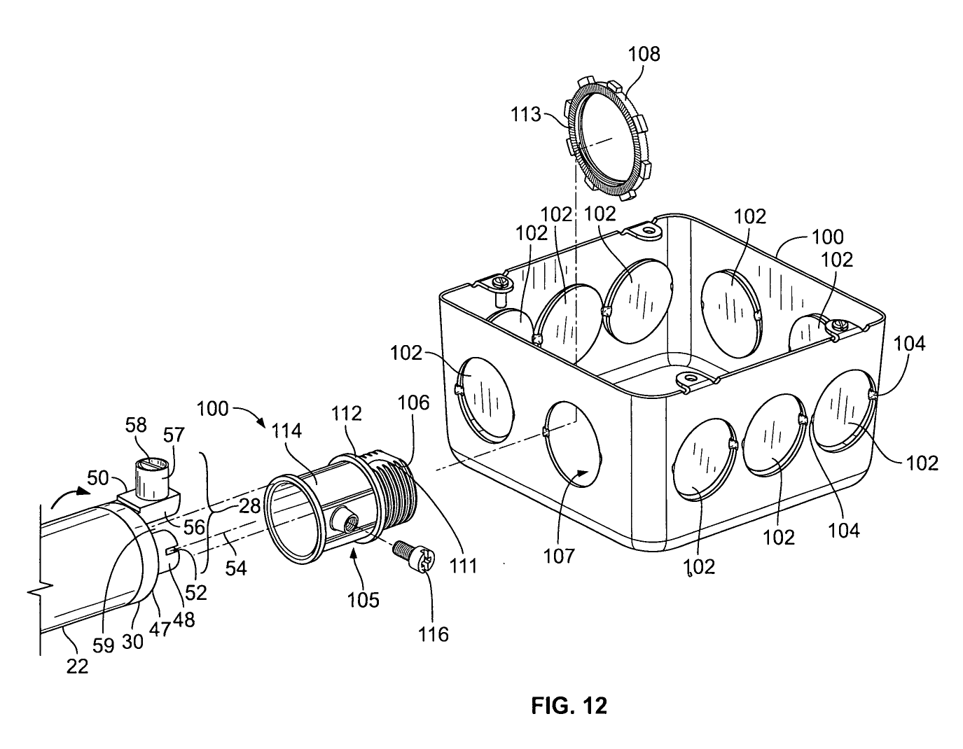

FIG. 12 depicts the multi-functional tool 20 and the manner in which the multi-functional tool 20 is used to connect a section of wire casing (not shown) to an electrical box 100. The electrical box 100 must first be prepared by removing a knockout 102 that is connected to the electrical box 100 by at least one connecting portions 104. In order to do so, a user grasps the multi-functional tool 20 by the shaft 22 with the first implement 24 pointing out and strikes the knockout 102 with the knockout hammer 44 of the first implement 24, thereby causing the knockout 102 to rotate inwardly. In the case of two or more connecting portion 104, all but one of the connecting portions 104 would be broken, allowing the knockout 102 to rotate inwardly. Thereafter, the user turns the tool 20 one-hundred and eighty degrees such that the second implement 28 is pointing out and inserts an edge of the knockout 102 into the slot 52 of the second implement 28. The tool 20 is twisted, thereby twisting the knockout 102 and breaking a remaining connecting portion 104 and allowing the user to dispose of the knockout 102.

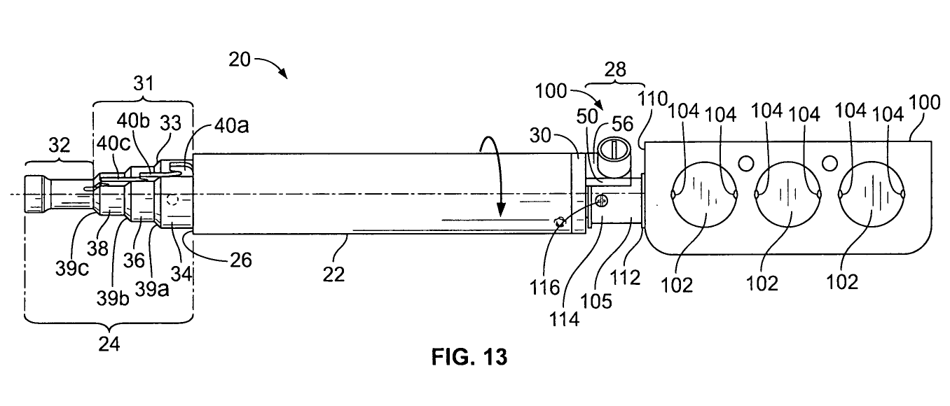

Still referring to FIGS. 12 and 13, the connector 105 is connected to the electrical box 100 by inserting a threaded end 106 of the connector 105 through a hole 107 formed by removing the knockout 102 and into an internal portion of the electrical box 100. A locking ring 108 is thereafter threaded by finger onto the threaded end 106 of the connector 105 until a wall 110 of the electrical box 100 is firmly secured between teeth 113 on the locking ring 108 and a lower surface 111 of an annular ring 112 extending outwardly from the connector 100. The second implement 28 is thereafter inserted into the connector 105 such that the first post 48 is inside the connector 105, the second post 50 is outside the connector 105, and a wall 114 of the connector 105 is disposed in the gap 59 formed between the posts 48, 50. The multi-functional tool 20 is then turned in a clockwise direction causing the second post 50 of the multi-functional tool 20 to interfere with a connector screw 116 extending outwardly from the connector 105, as seen in FIG. 13. As the tool 20 is further turned, the interference of the post 50 with the screw 116 causes rotation of the connector 105 to more securely fasten the connector 105 to the electrical box 100. During such operation, the user may need to grasp and hold the locking ring 108 while rotating the connector 105. Once the connector 105 is secured to the electrical box 100, a section of wire casing (not shown) is inserted into the connector 105 and the screw 116 is tightened using either the divider 58 disposed within the semi-cylindrical member 56 or the divider 46 disposed within the hollow cylindrical portion 45. The screw 116 is tightened such that an end thereof is driven into the section of wire casing to retain same within the connector 105.

Electrical boxes are generally attached to studs that are separated by sixteen inch centers, therefore limiting the size of tool that can be utilized with such boxes. The multi-functional tool 20, as described herein, is therefore preferably less than about nine inches in length. Optionally, the multi-functional tool 20 as described herein may include a hinge in a portion of the shaft 22 that allows the shaft 22 to be pivoted at the hinge up to a ninety degree angle. In such a tool, the hinge may include a locking mechanism to hold the shaft 22 of the multi-functional tool 20 at a selected angle. The hinge allows the tool to be maneuvered in tight spaces, for example, between studs or between a stud and a wall.

The multi-functional tool 20 as described herein may be utilized in a variety of environments, as long as the spacing between an electrical box and adjacent hardware, walls, surfaces, etc. is at least the length of the tool 20. If the spacing is less than the length of the tool 20, conventional methods such as those described above, may be utilized.

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

I claim:

1. A multi-functional tool comprising:
a shaft having first and second ends;
a first implement extending from the first end; and
a second implement extending from the second end and including a base and first and second posts extending from the base, wherein a gap is disposed between the first and second posts and adapted to receive a connector therebetween during locking of the connector to an electrical box.

2. A multi-functional tool of claim 1, wherein the shaft is cylindrical in shape.

3. The multi-functional tool of claim 1, wherein the first implement includes a deburring section formed of a body having a first cylindrical portion having a first diameter, a second cylindrical portion having a second diameter, and a third cylindrical portion having a third diameter, wherein the first, second, and third diameters are different.

4. The multi-functional tool of claim 3, wherein each of the first, second, and third cylindrical portions includes a hook-shaped member for deburring different sized sections of wire casing.

5. The multi-functional tool of claim 1, wherein a knockout hammer extends from the deburring section and includes a cylindrical portion.

6. The multi-functional tool of claim 5, wherein the knockout hammer further includes a divider extending across a central portion of the cylindrical portion to receive and tighten a connector screw.

7. The multi-functional tool of claim 1, wherein at least a portion of the first post is cylindrical and a slot is disposed in an end thereof in a central portion thereof.

8. The multi-functional tool of claim 1, wherein the second post is semi-cylindrical in shape and a locking member extends at about a ninety degree angle from the second post, such that when the connector is disposed between the first and second posts, the locking member interferes with a screw extending from the connector to rotate and tighten the connector.

9. A multi-functional tool comprising:
a shaft having first and second ends;
a first implement extending from the first end, wherein the first implement includes a knockout hammer; and
a second implement extending from the second end, wherein the second implement includes a base, first and second posts extending from the base, and a locking member extending at an angle of about ninety degrees from the second post.

10. The multi-functional tool of claim 9, the first implement further including a deburring section having a body having a first cylindrical portion having a first diameter, a second cylindrical portion having a second diameter, and a third cylindrical portion having a third diameter, wherein the first, second, and third diameters are different.

11. The multi-functional tool of claim 10, wherein each of the first, second, and third cylindrical portions includes a hook-shaped member for deburring different sized sections of wire casing.

12. The multi-functional tool of claim 9, wherein at least a portion of the first post is cylindrical and a slot is disposed in an end of the first post in a central portion thereof.

13. The multi-functional tool of claim 9, wherein the locking member includes a divider extending across a central portion thereof.

14. The multi-functional tool of claim 9, wherein the first and second posts are coupled to the base of the second end forming a gap that is large enough to accommodate a connector therebetween during locking of the connector to an electrical box.

15. The multi-functional tool of claim 9, wherein the knockout hammer includes a divider disposed in an end thereof and extending across a central portion thereof to receive and tighten a connector screw.

16. A method of using a multi-functional tool, the method comprising the steps of:
knocking out a portion of a knockout in an electrical box utilizing a knockout hammer of the tool;
inserting an edge of the knockout into a slot disposed in a cylindrical member extending from an end of the tool;
twisting the tool to remove the knockout from the electrical box;
inserting a threaded end of a connector into a hole formed in the electrical box by removal of the knockout;
attaching and rotating a locking ring along the threaded end of the connector;
inserting an end of the tool into a hollow portion of the connector, wherein a cylindrical wall of the connector is located between first and second spaced posts;
turning the tool in a clockwise manner until the electrical box is held tightly between the connector and the locking ring;
inserting a section of wire casing into the connector; and
securing the section of wire casing to the connector by rotating a connector screw in the connector into engagement with the section of wire casing to retain the section of wire casing within the connector.

17. The method of claim 16, wherein during the turning step, the second post interferes with a connector screw extending from the connector to cause rotation of the connector.
